(19) United States
(12) Patent Application Publication
(10) Pub. No.: US 2016/0010895 A1
(43) Pub. Date: Jan. 14, 2016

(54) OPTICALLY TRANSPARENT SINGLE-CRYSTAL CERAMIC RECEIVER TUBES FOR CONCENTRATED SOLAR POWER

(71) Applicant: ABENGOA SOLAR LLC, Lakewood, CO (US)

(72) Inventors: Luke Erickson, Lakewood, CO (US); Antonio Gavilan, Lakewood, CO (US)

(21) Appl. No.: 14/772,289

(22) PCT Filed: Feb. 13, 2014
(86) PCT No.: PCT/US14/16199

§ 371 Date: Sep. 2, 2015

Related U.S. Application Data
(60) Provisional application No. 61/787,440, filed on Mar. 15, 2013.

(51) Int. Cl. F24J 2/46; F24J 2/48; F03G 6/06; F24J 2/24

(52) U.S. Cl. CPC F24J 2/46; F24J 2/24; F24J 2/485; F03G 6/065; F24J 2002/4683

(57) ABSTRACT

Disclosed embodiments include solar power receiver tubes for a concentrated solar power receiver having a tube wall that is optically transparent to solar energy. Concentrated solar power systems and methods featuring the use of optically transparent receiver tubes are also disclosed. The optically transparent receiver tube may include a transparent tube wall fabricated from at least one of the following materials; single crystal alumina (synthetic sapphire), aluminum oxynitride, spinel, quartz or magnesium aluminum oxide.

### TECHNICAL FIELD

The embodiments disclosed herein are directed toward receiver tubes and a concentrated solar power receiver, which tubes are optically transparent to solar light energy over a suitable wavelength range. Also disclosed are apparatus, methods and systems for generating power from concentrated solar illumination which systems and methods utilize optically transparent receiver tubes.

### BACKGROUND

Concentrated Solar Power (CSP) systems utilize solar energy to drive a thermal power cycle for the generation of electricity. Considerable interest in CSP has been driven by renewable energy portfolio standards applicable to energy providers in the southwestern United States and renewable energy feed-in tariffs in Spain. CSP systems are typically deployed as large, centralized power plants to take advantage of economies of scale.

Accordingly, many electrical power providers are incorporating concentrated solar power generation facilities into their mix of electricity sources. In these facilities, concentrated solar energy provides the heat required to drive turbines for power generation using conventional steam or more exotic power cycles. CSP technologies include parabolic trough systems, linear Fresnel systems, central receiver or “power tower” systems with heliostat fields and dish/engine systems. In most cases, the reflective solar concentrating element or elements concentrates reflected sunlight upon the surface of a tube, an array of tubes or other receiver structure within which heat transfer material is passed or in circulated.

For example, the receiver of a heliostat-heated solar energy tower often includes receiver panels comprised of many metal tubes. The surface of the tubes is typically coated with a coating with high solar absorbance and relatively low infrared emittance, such as Pyromark 2500. Concentrated light is absorbed by the receiver tube outer coating as thermal energy. The thermal energy is conducted across the thickness of the tube and is transferred to the heat transfer material flowing therein. Therefore, a significant engineering challenge presented by a concentrated solar power generation facility using conventional receiver tubes is thermal resistance to the energy transfer between the photons at the surface of the receiver and the thermal energy exiting the receiver in the heat transfer material. This leads to higher tube surface temperatures which cause loss of heat through radiation and convection. The lost heat does not increase the temperature of the heat transfer material and thus contributes to reduced system efficiency.

The embodiments disclosed herein are directed toward overcoming one or more of the problems discussed above.

### SUMMARY OF THE EMBODIMENTS

Disclosed embodiments include a solar power receiver tube for a concentrated solar power receiver having a tube wall that is optically transparent to solar energy. The optically transparent receiver tube may include a transparent tube wall fabricated from at least one of the following materials; single crystal alumina (synthetic sapphire), aluminum oxynitride, spinel, quartz, magnesium aluminum oxide or another suitable ceramic or crystalline material.

In certain embodiments, the optically transparent receiver tube will include an absorptive coating operatively associated with an inner wall of the receiver tube. The absorptive coating serves as a thin absorber layer to absorb light energy and convert the light energy to heat. In certain instances, the receiver tube will also include a protective coating operatively associated with the inner surface of any absorptive coating. The protective coating may be boron nitride or a similar material.

Alternative optically transparent receiver tube embodiments will not include an absorber layer, and thus would typically not require any protective coating layer.

In certain embodiments, the inner, outer or both surfaces of the tube wall may be coating with an anti-reflective coating to reduce reflections and increase the transmission of light into and out of the tube wall. Alternatively, the inner or outer tube wall surfaces may be nanostructured to achieve anti-reflective properties. The disclosed optically transparent receiver tubes may have any cross sectional shape, including but not limited to circular, hexagonal, irregular six-sided polygonal, or rhomboidal.

The described optically transparent receiver tubes may be assembled in arrays, panels or other structures and implemented within a solar power receiver. Receiver embodiments may include a receiver housing and multiple optically transparent receiver tubes.

In embodiments where an absorptive coating is used, the receiver may further include an opaque or reflective heat transfer material, for example a metal or solid particle heat transfer material. In embodiments where no absorptive coating is used, the receiver may include a near-transparent, translucent or semi-opaque heat transfer material which directly absorbs and is heated by solar radiation. For example, the heat transfer material may be a molten salt, molten glass, another type of molten oxide or other similar material. In certain instances, a dopant such as graphite or chromium oxide may be added to the heat transfer material in embodiments where the heat transfer material directly absorbs incident sunlight. The dopant can serve to enhance the light absorption characteristics of a near-transparent or translucent heat transfer material.

In a receiver embodiment, the optically transparent receiver tubes may be arranged in linear parallel arrays within, for example, a cavity receiver. Alternatively, the optically transparent receiver tubes may be arranged in a circular array on the outside of a tower receiver configuration.

Alternative embodiments include solar power generating plants of any configuration featuring receivers having optically transparent receiver tubes as disclosed herein.

Alternative embodiments include methods of generating electricity with concentrated solar power plants of any configuration featuring receivers having optically transparent receiver tubes as disclosed herein.

### BRIEF DESCRIPTION OF THE DRAWINGS

FIG. 1 is schematic diagram of a concentrated solar power generation system.

FIG. 2 is schematic diagram representation of an optically transparent receiver tube with an absorptive inner wall coating as disclosed herein.

FIG. 3 is a graphic representation of the energy flow across the optically transparent receiver tube of FIG. 2.

FIG. 4 is schematic diagram representation of an optically transparent receiver tube with no absorptive inner wall coating utilizing an absorptive heat transfer material.

FIG. 5 is a graphic representation of the energy flow across the optically transparent receiver tube of FIG. 4.

FIG. 6 is schematic diagram representation of optically transparent receiver tubes arranged in a cavity receiver embodiment.

FIG. 7 is schematic diagram representation of optically transparent receiver tubes arranged in external tower receiver embodiment.

### DETAILED DESCRIPTION

Unless otherwise indicated, all numbers expressing quantities of ingredients, dimensions, reaction conditions and so forth used in the specification and claims are to be understood as being modified in all instances by the term “about”.

In this application and the claims, the use of the singular includes the plural unless specifically stated otherwise. In addition, use of “or” means “and/or” unless stated otherwise. Moreover, the use of the term “including”, as well as other forms, such as “includes” and “included”, is not limiting. Also, terms such as “element” or “component” encompass both elements and components comprising one unit and elements and components that comprise more than one unit unless specifically stated otherwise.

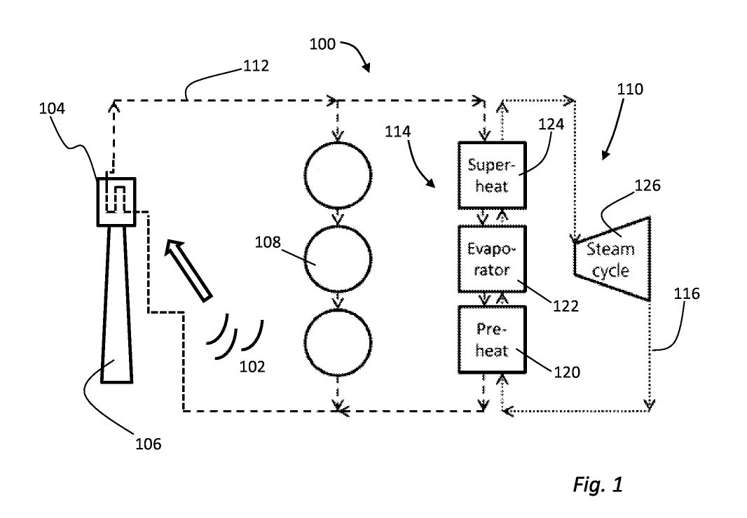

A representative configuration of a concentrated solar energy power generation system 100 is schematically illustrated in FIG. 1. The solar power generation system 100 may be considered to have multiple functional blocks including; one or more heliostats 102 or other reflective solar energy concentrators and a receiver 104 positioned on a tower 106 to receive reflected and concentrated solar illumination from the heliostat field 102. A system 100 may also include one or more thermal energy storage subsystems 108 and one or more power blocks 110. A typical commercial installation will have many hundreds of heliostats per tower and receiver. A system may also have many towers and thermal energy storage subsystems for each power block.

The solar energy concentrator elements may be heliostats 102 or may be of any other known type, including but not limited to, parabolic trough reflectors, Fresnel lenses or similar elements. In all cases, the solar concentrator elements concentrate reflected sunlight upon the surface of an array of tubes or other receiver structure within which heat transfer material is flowed or circulated. The heat transfer material is thus heated by concentrated sunlight to a temperature sufficient to drive a power generation process as described below.

The receiver 104, thermal energy storage system 108 and power block 110 are each maintained in thermal communication through a heat transfer material circuit 112. The heat transfer material circuit 112 has heat transfer fluid or an alternative heat transfer material flowing within pipes, valves, pumps, heat exchange elements and other structures comprising the circuit 112. The term “heat transfer material” is used herein instead of the more commonly used “heat transfer fluid” because in certain embodiments the heat transfer material of the disclosed embodiments is moved, stored and utilized as a non-fluid solid or as a phase-change material which changes phases between a solid or liquid state at various points within the heat transfer material circuit.

Materials suitable for use as a heat transfer material include salt, glass, thermal oil, metal, air, carbon dioxide, organic and inorganic polymers any of which may be in the gaseous, liquid, solid, supercritical phases, or any combination of these materials. In particular, the heat transfer material could be comprised of a nitrate, carbonate, bromide, chloride, fluoride, hydroxide, or sulfate salt, zinc, boron, beryllium, lead, magnesium, copper, aluminum, tin, antimony, manganese, iron, nickel or silicon, an alloy of any metals, a plastic, a wax organic material or a miscible or immiscible mixture of any of the above that is capable of storing heat in a sensible and/or latent form. The specific choice of a heat transfer material is determined by specific application requirements. As detailed below, certain heat transfer materials used with optically transparent receiver tubes that do not have an absorptive inner coating must directly absorb concentrated solar irradiation and convert this electromagnetic energy to thermal energy. In addition, in systems operating at high temperatures, typically above around 600C, metals such as aluminum alloys may be used as the heat transfer material, while in systems operating at medium temperatures, typically around 400C, nitrate salts may be the most suitable heat transfer material. At still lower temperatures, typically below 200C, hydrate salts and organic waxes may be the most suitable heat transfer material.

The power block 110 includes various steam train components 114 which provide for heat exchange between heat transfer material flowing in the heat transfer fluid circuit 112 and a working fluid flowing in a working fluid circuit 116. The working fluid may be water (steam), CO₂, or any other substance suitable for driving a power generation cycle of any selected type. Typically, a steam-based power block 110 includes at least the following steam train components; a pre-heater 120, an evaporator 122 and a super-heater 124, arranged in order from lesser to greater operational temperature. In the various steam train components 114, heat is exchanged between the heat transfer material in the heat transfer fluid circuit 112 and the steam circuit 116 resulting in the production of super heated steam which may be used to drive a steam turbine 126 of and all for power generation.

In each of the embodiments disclosed herein, solar energy in the form of concentrated light illuminates a receiver. As noted above, many receiver designs include one or typically several receiver tubes arranged in an array designed to efficiently receive the concentrated sunlight. As defined herein, a receiver tube may be any tube-like structure or conduit having any suitable cross sectional and overall shape, size or length. A receiver tube will have tube walls of a suitable thickness and may include joints, threading or other structures. The receivers on most commercially implemented concentrated solar power plants use panels comprised of many metal receiver tubes. The surface of the tubes is typically coated with a high solar absorbance and relatively low infrared emittance material such as Pyromark 2500. Concentrated light is absorbed by the coating then the energy is conducted across the thickness of the tube and is transferred to the heat transfer material within the tubes.

In the embodiments disclosed herein, the metal receiver tubes are replaced with optically transparent receiver tubes which in certain embodiments may be fabricated from a single crystal ceramic material. The disclosed embodiments therefore eliminate a major source of resistance to the energy transfer between the photons at the surface of the receiver and the thermal energy exiting the receiver in the heat transfer material. The use of optically transparent receiver tubes provides several advantages, including but not limited to the following. First, optically transparent receiver tubes provide for significantly reduced energy transfer resistance across the receiver tube walls. Therefore, the surface temperature of the receiver will be substantially decreased at an equivalent heat transfer fluid temperature. This in turn will reduce radiative and convective losses. Second, since an optically transparent receiver tube facilitates energy transfer into an interior portion of the tube as light rather than heat, any thermal gradient across the thickness of the tube will be much lower than in a conventional design. A reduced thermal gradient will in turn reduce the thermal stress and bending moment placed upon receiver elements. Third, the foregoing reductions in temperature and thermal stress allow a receiver having optically transparent elements to utilize significantly higher heat transfer material operational temperatures, which serves to increase the thermal-to-electric cycle efficiency. Fourth, the concentration ratio or total solar flux level at the receiver can be increased for each of the above reasons, which reduces the receiver size, reducing cost and heat losses.

Recent material advances have made the development of a solar receiver having optically transparent receiver tubes viable. Certain optically transparent ceramics such as synthetic sapphire (single crystal alumina, Al₂O₃) are now produced on an industrial scale by various providers including but not limited to Saint Gobain and Crystal Systems Inc. Processes utilizing the heat exchanger method or edge defined film-fed growth process result in crystals that can be grown in monolithic single crystal tubes or sheets. Processes for growing large crystals of other materials such as aluminum oxynitride (Al₂₃O₂₇N₅), spinel (MgAl₂O₄), magnesium aluminum oxide, quartz (SiO₂), and others are under development and may also soon be commercially available for the preparation of optically transparent receiver tubes in the required sizes and quantities.

The foregoing and other crystalline or ceramic structures have high strength, particularly in compression but also in tension. These materials are also exceptionally resistant to corrosion. Optically, the foregoing single crystal ceramic materials provide for near perfect transmission of the solar spectrum and may be partially absorptive in the infrared spectrum emitted by a heated heat transfer material.

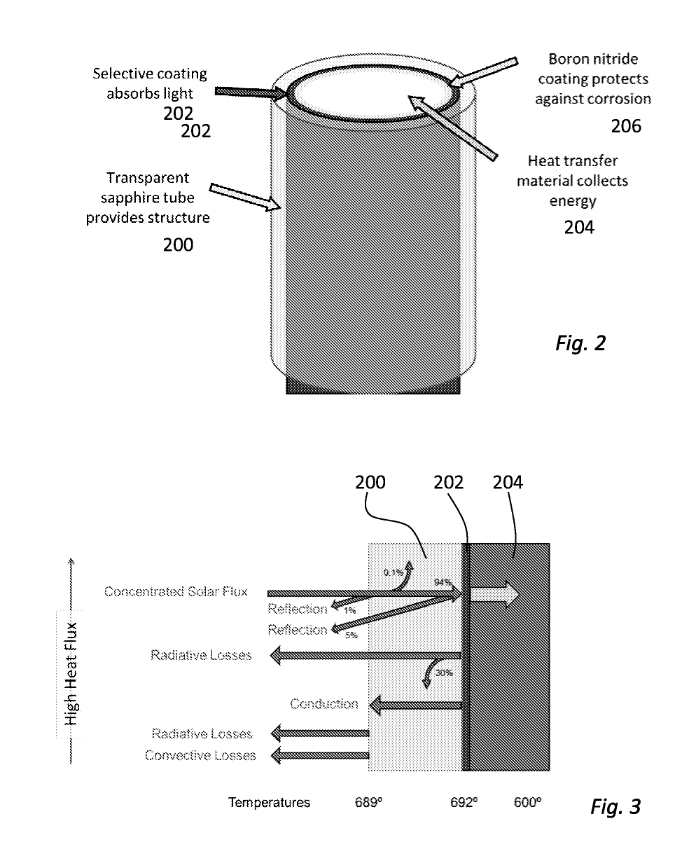

Various alternative receiver tube and optional absorber designs using transparent tubes would be advantageous for concentrated solar power receivers. In one embodiment, schematically illustrated in FIG. 2, a transparent single crystal alumina receiver tube 200 provides mechanical structure and optical advantages as described herein. The term “optically transparent” is defined herein to mean that at least a significant portion of incident solar light through the tube walls as light without being absorbed and converted to thermal energy.

Relatively undiminished transmission of light into and out of the optically transparent tube walls may be enhanced by the application of an anti-reflective coating of any suitable type to the outer or inner tube wall surfaces, or by nanostructuring the tube wall surfaces to decrease reflection. Thus, solar illumination is not substantially reflected from a tube surface and is not absorbed and converted to thermal energy by the tube material. It is important to note that an optically transparent material may not be optically transparent at all wavelengths. For example, it may be advantageous if a tube material is optically transparent at visible light wavelengths yet partially or substantially opaque at infrared wavelengths.

In the embodiment of FIG. 2, the inner surface of the tube 200 is coated with a high-absorptivity low-emissivity coating 202 which serves to convert the energy from incident electromagnetic radiation to thermal energy. Thus, the coating 202 comprises an absorber located at the interface between the tube and the heat transfer material 204. Therefore, little or no energy is wasted heating the tube walls. In addition, thermal resistance to heat transfer through the thin absorber is minimized Additionally, a second coating 206, for example, boron nitride may be added between the absorptive coating 202 and the heat transfer material 204 in the fluid flow channel to prevent corrosion and erosion of the absorptive coating by the heat transfer material. In this receiver tube configuration, heat is transferred from the absorptive coating 202 to the heat transfer material 204 by conduction and convection. This optically transparent receiver tube configuration is therefore extremely advantageous for systems featuring opaque or reflective heat transfer materials such as molten metals, opaque oils, solid particles or similar materials

FIG. 3 a diagram of the energy flow across an optically transparent receiver tube 200 which features an absorptive coating 202 on the inner surface, as illustrated in FIG. 2. Sunlight penetrates the optically transparent tube material and is substantially absorbed by the coating 202. Most of the light is converted to heat and transmitted to the heat transfer material 204. Some incident energy is reflected as light, emitted as infrared radiation, or carried away by convection.

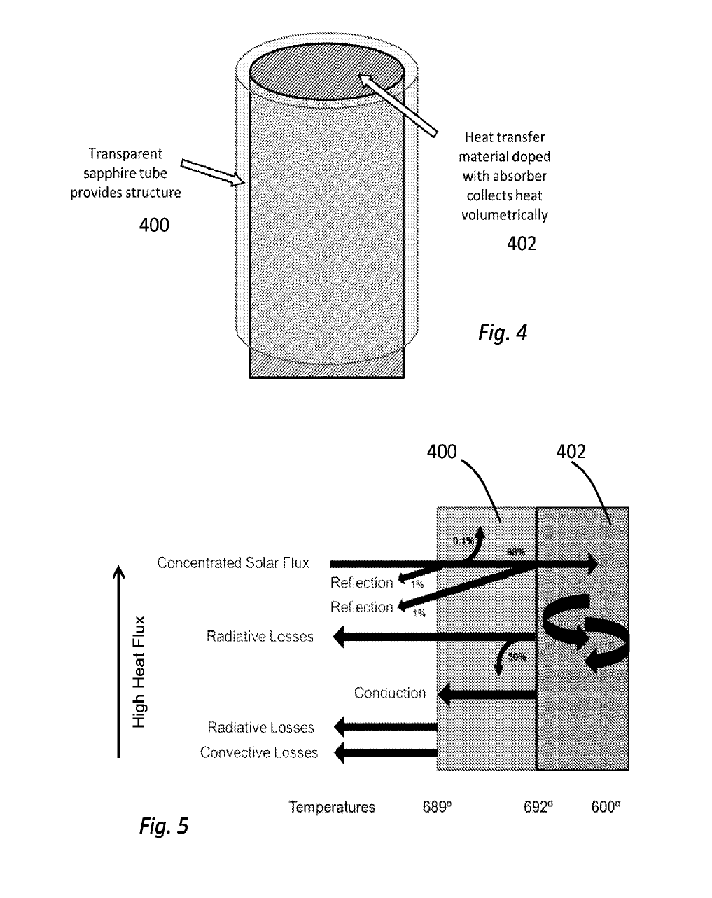

In an alternative embodiment of optically transparent receiver tube as illustrated in FIG. 4, light is absorbed directly by a translucent, semi-opaque or otherwise absorptive heat transfer material. Thus, the FIG. 4 embodiment includes an optically transparent receiver tube 400 containing heat transfer material 402, but without any coating between the inner tube walls and heat transfer material. In the FIG. 4 embodiment, concentrated visible light solar energy is absorbed directly by heat transfer material 402 and converted to thermal energy. In certain instances the heat transfer material may inherently absorb solar energy. Alternatively, the heat transfer material may be modified to provide better absorption characteristics. For example, molten salt may be doped with a small amount of graphite, chromium oxide, or other pigment-type material such that some light is absorbed at the front of the receiver tube but much of it passes through to the middle and the back of the tube where it is further absorbed. Ideally, all or very nearly the entire energy of incident light would be absorbed over the full thickness of the heat transfer fluid flow channel. The FIG. 4 embodiment is advantageous for transparent or translucent heat transfer materials such as salts or oxides (molten glasses).

FIG. 5 a diagram of the energy flow across an optically transparent receiver tube 400 without an absorptive coating on the inner surface as illustrated in FIG. 4. The incident sunlight penetrates the clear tube material and is absorbed by the heat transfer material 402. Most of the light is converted to heat in the heat transfer material 402. Some incident energy is reflected as light, emitted as infrared radiation, or carried away by convection.

In certain embodiments, the individual optically transparent receiver tubes have a substantially circular cross-section. This configuration has the advantage of being very similar to current receiver designs so existing metal tubes can be replaced, leaving the balance of the receiver unchanged. In addition, it may be somewhat easier to construct a heat transfer material circuit with conventional pipe-shaped optically transparent receiver tubes by machining threads into the ends of the tubes and mounting them into conventional manifold piping.

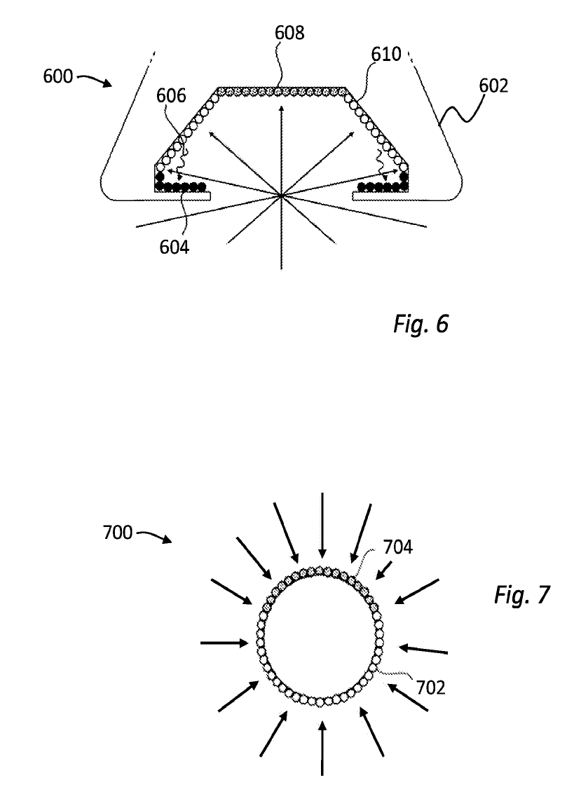

Optically transparent receiver tubes may be arranged into arrays or panels to form the entire light receiving surface of a receiver. In certain embodiments the receiver tubes may be arranged in multiple layers, for example where a substantially transparent heat transfer material is used with optically transparent receiver tubes without any absorptive coating. For example, as shown in FIG. 6, a cavity receiver 600 may include a housing 602 which contains multiple parallel arrays of receiver tubes 604-610 which are, at least in part, optically transparent. Certain receiver tubes in the FIG. 6 embodiment are directly illuminated, such as tubes 606, 608 and 610. Other tubes 604 are illuminated by reflected light or thermal radiation. Various other receiver configurations could be implemented with optically transparent receiver tubes. For example, as shown in FIG. 7, an external tower receiver 700 could include receiver tubes 702, 704 having a circular cross-section arranged in a circular array.

Alternative configurations of receiver tubes could utilize optically transparent tubes with a hexagonal, irregular 6-sided polygonal (“stretched hexagon”), or rhomboidal cross section. The advantage of this configuration is that single crystal alumina has a trigonal crystal structure so all the receiver tube surfaces could be aligned with crystal boundaries.

Alternatively, two or more parallel plates of an optically transparent material such as single crystal alumina could be joined at the edges to create a large receiver tube or channel with a rectangular cross section. The plates may be joined with or without spacers by fasteners of any suitable type or ceramic brazing. Plates may be less expensive or easier to manufacture than tubes having a circular or other cross-section and less total material may be used. Any of the described geometries could be arranged into a cavity-type or external-type tower receiver configuration such as illustrated in FIGS. 6 and 7.

Systems and apparatus as disclosed herein provide for high efficiency and low cost. As noted above, low thermal stress across the thickness and across the diameter of an optically transparent receiver tube allows the receiver to be operated at very high flux rates. For a given power rating, this means the receiver can be smaller when compared to a conventional receiver sized to produce the same output. For example, if the use of optically transparent receiver tubes provides for the average flux on a receiver tube to be increased from 800 kW/m² to 4000 kW/m² (a factor of 5 increase), the receiver surface area can decreased by a factor of 5. This vastly reduces the total amount of material used to construct a receiver of a given output capacity.

Furthermore, a relatively small receiver has lower heat losses. The thermal losses are proportional to the receiver surface area and the receiver surface temperature. Since both metrics are smaller for a receiver implemented with the disclosed optically transparent receiver tube technology, overall heat losses are lower. Additionally, reflective losses are very low leading to electromagnetic to thermal energy conversion efficiencies of 90-95% compared to 70-90% for conventional opaque receiver tube technologies.

In addition, operating a receiver at higher temperature allows the thermal to electric conversion efficiency of the generation system to increase. For example, a typical commercial molten salt power tower operating with a hot temperature of 565° C. has a power cycle efficiency of about 42%. Using the disclosed optically transparent receiver tube technology and suitable heat transfer materials allowing for a high heat transfer material temperature of 1000° C., the power cycle efficiency would be about 56% while the receiver efficiency would only decrease by 1-2%. In theory, transparent receiver tube technology could be used to achieve even higher temperatures at the receiver, but downstream components will likely limit the maximum operating temperatures to about 1000° C. By increasing the thermal-electric conversion efficiency from 42% to 56% without significantly changing the receiver efficiency, ⅓ fewer heliostats would be required to supply the heat necessary for a given electric output. Heliostat costs often dominate the cost of large concentrated solar power installations, so this reduction will contribute significantly to reducing the total cost of the electricity generated by a given system. Additionally, high receiver temperatures increase the storage density of a suitable heat transfer material. This in turn can reduce the size of a suitably sized thermal storage system which would offset some or all of any increase in generation cost due to higher temperatures. Large high temperature thermal storage systems can contribute to making a concentrated solar power system more dispatchable to meet load requirements.

Alternative embodiments include solar power generating plants of any configuration featuring receivers having optically transparent receiver tubes as disclosed herein. Alternative embodiments include methods of generating electricity with concentrated solar power plants of any configuration featuring receivers having optically transparent receiver tubes as disclosed herein.

Various embodiments of the disclosure could also include permutations of the various elements recited in the claims as if each dependent claim was a multiple dependent claim incorporating the limitations of each of the preceding dependent claims as well as the independent claims. Such permutations are expressly within the scope of this disclosure.

While the embodiments disclosed herein have been particularly shown and described with reference to a number of alternatives, it would be understood by those skilled in the art that changes in the form and details may be made to the various configurations disclosed herein without departing from the spirit and scope of the disclosure. The various embodiments disclosed herein are not intended to act as limitations on the scope of the claims. All references cited herein are incorporated in their entirety by reference.

1-10. (canceled)

11. A concentrated solar power receiver comprising:
a receiver housing; and
a plurality of transparent receiver tubes operatively associated with the receiver housing; a portion of said receiver tubes being optically transparent to solar energy:,
wherein the optically transparent receiver tubes are arranged in one or more arrays of receiver tubes.

12. The concentrated solar power receiver of claim 11 wherein the optically transparent receiver tubes comprise walls comprising at least one of the following materials; single crystal alumina, aluminum oxynitride, spinel, magnesium aluminum oxide and quartz.

13. The concentrated solar power receiver of claim 11 further comprising an antireflection coating applied to one or both of an inner surface and an outer surface of a tube wall of one or more of the transparent receiver tubes.

14. The concentrated solar power receiver of claim 11 further comprising a nanostructured surface to reduce reflection formed in one or both of an inner surface and an outer surface of the tube wall of one or more of the transparent receiver tubes.

15. The concentrated solar power receiver of claim 11 further comprising an absorptive coating operatively associated with an inner surface of the wall of one or more of the transparent receiver tubes, which absorptive coating absorbs solar energy.

16. The concentrated solar power receiver of claim 15 wherein the absorptive coating is opaque.

17. The concentrated solar power receiver of claim 15 further comprising a heat transfer material flowing in a heat transfer material circuit defined in part by the transparent receiver tubes; wherein the heat transfer material comprises a metal.

18. The concentrated solar power receiver of claim 15 further comprising a protective coating operatively associated with an inner surface of the absorptive coating, opposite the inner surface of the wall of the receiver tube.

19. The concentrated solar power receiver of claim 14 wherein the protective coating comprises boron nitride.

20. The concentrated solar power receiver of claim 11 further comprising a heat transfer material flowing in a heat transfer material circuit defined in part by the transparent receiver tubes; wherein the heat transfer material comprises a material providing for the direct absorption of solar energy.

21. The concentrated solar power receiver of claim 20 wherein the heat transfer material further comprises one of a molten salt, a molten oxide or a molten glass.

22. The concentrated solar power receiver of claim 21 wherein the heat transfer material further comprises a dopant providing for enhanced absorption of solar energy by the heat transfer material.

23. The concentrated solar power receiver of claim 22 wherein the dopant of the heat transfer material comprises at least one of graphite or chromium oxide.

24. The concentrated solar power receiver of claim 9 wherein the optically transparent receiver tubes are arranged in one or more linear parallel or circular parallel arrays of receiver tubes.

25. (canceled)

26. A concentrated solar power generating plant comprising:
a receiver comprising a receiver housing and a plurality of receiver tubes operatively associated with the receiver housing; a portion of said receiver tubes being optically transparent to solar energy;
a heat transfer material flowing in a heat transfer material circuit defined in part by the optically transparent receiver tubes;
one or more reflectors configured to concentrate reflected sunlight on the optically transparent receiver tubes; and
an electrical power generation block receiving thermal energy from the heat transfer material.

27. The concentrated solar power generating plant of claim 26 wherein the electrical power generation block comprises:
a working fluid flowing in a working fluid circuit, the working fluid being configured to receive thermal energy from the heat transfer material;
a turbine configured to produce mechanical energy from thermal energy in the working fluid; and
a generator operatively associated with the turbine configured to generate electrical current.

28. The concentrated solar power generating plant of claim 26 further comprising thermal energy storage in thermal communication with the heat transfer material.

29. A method of generating electricity comprising:
providing a receiver comprising a receiver housing and a plurality of receiver tubes operatively associated with the receiver housing; a portion of said receiver tubes being optically transparent to solar energy;
providing a heat transfer material flowing in a heat transfer material circuit defined in part by the transparent receiver tubes;
providing one or more reflectors configured to concentrate reflected sunlight on the transparent receiver tubes;
providing an electrical power generation block configured to receive thermal energy from the heat transfer material;
positioning the one or more reflectors to concentrate reflected sunlight on the optically transparent portion of the optically transparent receiver tubes, causing the heat transfer material to become heated; and
utilizing thermal energy from the heated heat transfer material to generate electrical energy in the power generation block.

30. The concentrated solar power receiver of claim 11 wherein the optically transparent receiver tubes comprise receiver tube walls defining at least one of a circular, hexagonal, irregular six sided polygonal or rhomboidal cross section.
